(19) United States
(12) Patent Application Publication
(10) Pub. No.: US 2014/0317197 A1
(43) Pub. Date: Oct. 23, 2014

(54) Systems And Methods For Processing Electronic Correspondence

(71) Applicants: Suzann Hua, Lisle, IL (US); Ahmed N. Zaki, Lisle, IL (US)

(72) Inventors: Suzann Hua, Lisle, IL (US); Ahmed N. Zaki, Lisle, IL (US)

(73) Assignee: Alcatel-Lucent USA Inc., Murray Hill, NJ (US)

(21) Appl. No.: 13/864,608

(22) Filed: Apr. 17, 2013

(51) Int. Cl. H04L 12/58

(52) U.S. Cl. CPC H04L 51/34
USPC 709/206

(57) ABSTRACT

Systems and methods for processing electronic correspondence such as, for example, email messages, text messages, and the like are provided. In one aspect, one or more electronic messages are received for delivery to an intended recipient. Information within the electronic messages (e.g., sender name/address or one or more keywords) is compared and matched with or one more criteria provided by the intended recipient, and prioritized scheduled time(s) for delivery of the one or more received electronic messages to the intended recipient are determined based on the comparison.

### TECHNICAL FIELD

The present disclosure is directed towards communication systems. More particularly, it is directed towards systems and methods for processing electronic correspondence transmitted over a network.

### BACKGROUND

This section introduces aspects that may be helpful in facilitating a better understanding of the systems and methods disclosed herein. Accordingly, the statements of this section are to be read in this light and are not to be understood or interpreted as admissions about what is or is not in the prior art.

Networked systems have enabled an unprecedented amount of information to be electronically transmitted to users. While such information may be generally desired by consumers for its speed and convenience over other forms of communication, the sheer amount of electronic correspondence clamoring for a recipient's attention such as email messages, text messages, social media messages, faxes, etc., can be challenging for the recipient to manage in an efficient manner.

### BRIEF SUMMARY

Systems and methods that enable prioritized delivery of electronic correspondence such as email messages, text messages, social messages, faxes, and the like to an intended recipient of the electronic correspondence in accordance with a customized delivery schedule are provided. In various aspects, a recipient may actively or dynamically customize the electronic correspondence delivery schedule based on the recipient's specific needs.

In one aspect, the system and method includes receiving a first electronic correspondence for delivery to a client application; determining that information in the first electronic correspondence matches one or more criteria in a first delivery schedule; and, determining a first scheduled time based on the first delivery schedule for delivering the first electronic correspondence to the client application, the first scheduled time being determined based on the one or more criteria in the first delivery schedule.

In another aspect, the system and method includes withholding delivery of the first electronic correspondence to the client application at least until the first scheduled time determined based on the one or more criteria in the first delivery schedule. In a further aspect, withholding delivery of the first electronic correspondence to the client application further includes storing the first electronic correspondence in a first buffer separate from a second buffer; and, automatically moving, at least after the first scheduled time, the first electronic correspondence from the first buffer to the second buffer for delivery of the first electronic correspondence to the client application.

In another aspect, the system and method includes receiving a second electronic correspondence for delivery to the client application, the second electronic correspondence being received prior to receiving the first electronic correspondence; determining that information in the second electronic correspondence matches one or more criteria in a second delivery schedule; and, determining a second scheduled time for delivering the second electronic correspondence to the client application, the second scheduled time being determined based on the one or more criteria in the second delivery schedule and, the second scheduled time for delivering the second electronic correspondence being later than the first scheduled time for delivering the first electronic correspondence.

In a further aspect, the system and method includes determining the second electronic correspondence has a lower priority than the first electronic correspondence based on a determination that the second scheduled time for delivering the second electronic correspondence is later than the first scheduled time for delivering the first electronic correspondence, and, withholding delivery of the second electronic correspondence to the client application at least until the second scheduled time determined based on the one or more criteria in the second delivery schedule.

In another aspect, the system and method includes receiving a third electronic correspondence for delivery to the client application, the third electronic correspondence being received at a time subsequent to receiving the first and the second electronic correspondence; determining that information in the third electronic correspondence opposes the one or more criteria in the first and the second delivery schedule; and, determining that the third electronic correspondence has a higher priority than the first electronic and the second electronic correspondence.

In a further aspect, the system and method includes delivering the third electronic correspondence to the client device at a time prior to delivering the first electronic correspondence and the second electronic correspondence to the client application.

In another aspect, the system and method includes identifying a recipient for the first electronic correspondence; and, selecting the first delivery schedule from a plurality of schedules based on the identity of the recipient for the first electronic correspondence.

In another aspect, the system and method includes identifying one or more keywords in the information in the first electronic correspondence; and, selecting the first delivery schedule from a plurality of schedules based on the one or more keywords identified in the information in the first electronic correspondence.

In another aspect, the system and method includes determining the first scheduled time for delivering the first electronic correspondence and at least one of the one or more criteria in the first delivery schedule based on input received from the client application.

### BRIEF DESCRIPTION OF THE DRAWINGS

FIG. 1 illustrates an example of an electronic correspondence system in accordance with various aspects of the disclosure.

FIG. 2 illustrates an example of a customized per-recipient delivery schedule in accordance with an aspect of the disclosure.

FIG. 3 illustrates an example of a process flow diagram for scheduled delivery electronic correspondence in accordance with an aspect of the disclosure.

FIG. 4 illustrates a block-diagram example of an apparatus for implementing various embodiments of the disclosure.

### DETAILED DESCRIPTION

As used herein, the term, “or” refers to a non-exclusive or, unless otherwise indicated (e.g., “or else” or “or in the alternative”). Furthermore, as used herein, words used to describe a relationship between elements should be broadly construed to include a direct relationship or the presence of intervening elements unless otherwise indicated. For example, when an element is referred to as being “connected” or “coupled” to another element, the element may be directly connected or coupled to the other element or intervening elements may be present. In contrast, when an element is referred to as being “directly connected” or “directly coupled” to another element, there are no intervening elements present. Similarly, words such as “between”, “adjacent”, and the like should be interpreted in a like fashion.

FIG. 1 illustrates an example of an electronic correspondence system 100 in accordance with one aspect of the disclosure. System 100 includes a server 102 and client devices 104, 106 that are communicatively interconnected with each other via a network 108. While only a few components are shown in FIG. 1, a typical implementation may include any number of servers 102 and client devices 104, 106. Furthermore, system 100 may also include other interconnected devices such as routers, gateways, access points, switches, and other components that are typically employed for enabling communication over a network.

The network 108 may be any type of wired and/or wireless network. For example, the network 108 may be a Wide Area Network (“WAN”) such as the Internet; a Local Area Network (“LAN”) such as an intranet; a Personal Area Network (“PAN”), a satellite network, a cellular network, or any combination thereof. In addition to the foregoing, the network 108 may also include a telephone exchange network such as a Public Switched Telephone Network (“PSTN”), Private Branch Exchange (“PBX”), or Voice over IP (“VoIP”) network, for example.

The client devices 104, 106 may be a personal computer (“PC”), a laptop, a smart phone, a personal digital assistant (“PDA”), a tablet, a wireless handheld device, a set-top box, a gaming console, or any computing device suitably configured to provide functionality desired by an end user. In one embodiment, client devices 104, 106 respectively include executable client applications 110, 112. Upon execution by a processor, client applications 110, 112 respectively configure or enable client devices 104, 106 to receive/transmit textual or non-textual electronic correspondence such as email messages, text messages, social messages, faxes, voice-mail messages, and the like from/to other client devices over the network 108.

Server 102 may be a general purpose computer, a dedicated workstation, a mainframe/mid-frame computer, or any computing device. In one aspect, server 102 may be implemented as a number of physically or logically separate computing units that are directly or indirectly interconnected to each other via the network 108. In one embodiment, server 102 includes an executable server application 114, which, upon execution by a processor, configures the server 102 to receive the electronic correspondence transmitted from one or more client devices over the network, and to process and forward the electronic correspondence to other client devices for presentation to the intended recipient(s) of the electronic correspondence.

Client devices 104, 106 and the server 102 may be configured to communicate with each other over the network 108 using one or more network protocols. Some examples of network protocols include wireless communication protocols such as 802.11a/b/g/n, Bluetooth, or WiMAX; transport protocols such as Transfer Control Protocol (“TCP”) or User Datagram Protocol (“UDP”); Internet layer protocols such as the Internet Protocol (“IP”); application-level protocols such as Hyper Text Transfer Protocol (“HTTP”), Simple Message Service (“SMS”) protocol, Simple Mail Transfer Protocol (“SMTP”), Internet Message Access Protocol (“IMAP”), Post Office Protocol (“POP”), Session Initiation Protocol (“SIP”), a combination of any of the aforementioned protocols, or any other type of network protocol now known or later developed.

In one embodiment, the electronic correspondence includes email messages transmitted by one end user (“sender”) to another end user (“intended recipient”) over the network. In accordance with this embodiment, client applications 110, 112 may be email client applications which respectively configure client devices 104, 106 to transmit and receive email messages. In addition, server application 114 may be an email server application which configures server 102 to receive, process, and forward email messages from one client device to another client device over the network.

A respective sender at client device 102, 104 may use client applications 110, 112 to create and send one or more email messages which may be transmitted over the network to server 102 for ultimate delivery to another client application associated with an intended recipient. Some examples of email client applications which may be used by the senders or the intended recipients of the email messages include Microsoft Outlook, IBM Lotus Notes, and web-based applications such as Google's Gmail application, Yahoo's email application, and Microsoft's Hotmail application.

Client devices 104, 106 and the server 102 may receive and transmit email messages using one or more proprietary or interoperable email messaging protocols. Some examples of the interoperable email messaging protocols that may be implemented by the server 102 for receiving and transmitting email messages from one proprietary email client application to a different proprietary email client application include protocols such as IMAP, POP, or SMTP.

The email messages received by the server 102 may include a sender email address identifying the sender of the email message and a recipient email address identifying the intended recipient of the email message. The email message may also include various headers, a subject line, a body and/or one or more attachments, which may be encoded in various formats. By way of example, any combination of plain text, HTML, XML, and/or one more MIME extensions may be used to encode various sections or attributes of the email message. The MIME extensions may be used to attach various documents, images, audio, or video into the email message.

In one aspect, the server 102 includes a set of one or more customized delivery schedules 116 associated with a particular intended recipient of one or more email messages received by the server. Each customized delivery schedule in the set of delivery schedules 116 includes information that is used by the server 102 for filtering particular email messages received by the server 102 and for withholding the delivery of the filtered email messages to the intended recipient until a particular time (or time window) specified in the respective delivery schedule. More generally, the server 102 may include different sets of one or more delivery schedules 116, where each of the different sets may be customizable by a different intended recipient based on his or her preferences.

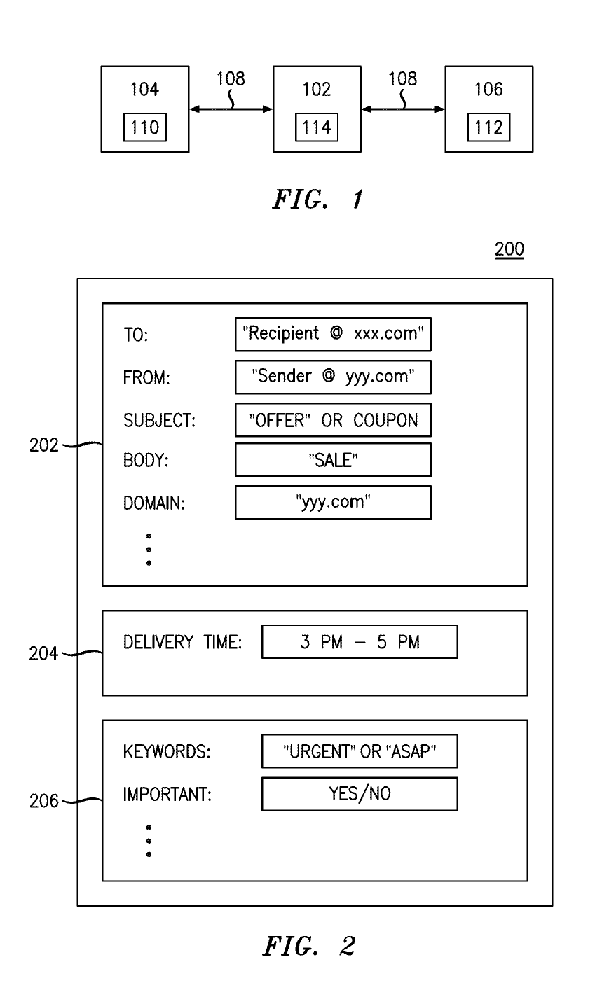

FIG. 2 illustrates a block-diagram example of a customized delivery schedule 200. In one aspect, the customized delivery schedule 200 includes one or more conditions 202, a delivery time 204, and one or more exceptions 206, each of which is now described below.

The one or more conditions 202 are used for identifying (e.g., filtering) email messages received by the server 102 by comparing or matching one or more criteria specified by the conditions 202 with information included in (or about) the received email messages. For example, the one or more conditions 202 may include criteria specifying a sender's name or email address (e.g., “sender@yyy.com”) and the intended recipient's name or email address (e.g., “recipient@xxx.com”). The conditions 202 may also include criteria specifying one or more keyword(s) of a subject (e.g., “offer” or “coupon”) or particular keyword(s) of the contents (e.g., “sale”). Yet additional conditions may specify other criteria that may be matched with information included in, for example, one or more headers of the email messages, such as the sending domain of the email message (e.g., “yyy.com”), the time when the email message was sent (or received), the type of email message (rich text or plain text), whether the email message is a new email message, a reply email message, a forwarded email message, etc.

While a particular set of conditions 202 are illustrated in FIG. 2 for explanation purposes, it will be appreciated that typical embodiments may include fewer or greater number of conditions 202. Furthermore, it will also be understood that the various conditions 202 and the respective criteria specified by the conditions may be defined using logic rules such as “and”, “or”, “not”, and the like.

Delivery time 204 may specify a prioritized time for delivery for those email messages that include information matching the criteria specified in the one or more conditions 202 of delivery schedule 200 (hereinafter referenced as “matching email messages”). For example, the delivery time 204 may specify the intended recipient's preference for receiving matching email messages at a particular time or times of the day (e.g., 3 PM and/or 5 PM), during a particular window of time during a day (e.g., between 3 PM-5 PM), or before or after particular time or times of day (e.g., before 10 AM and/or after 7 PM). In addition to specifying a preferred prioritized time of delivery, the delivery time 204 may also identify particular days or dates when an intended recipient may prefer to receive the matching email messages. By way of a specific example, the delivery time 204 may indicate the intended recipient's preference to receive matching email messages between 3 PM and 5 PM on particular days (e.g., every Monday or Wednesday) of the week. In general, messages associated with an earlier designated time of delivery may be deemed to be of higher priority for the intended recipient relative to other messages having a relatively later designated time of delivery, which may be considered to have a lower priority.

The criteria specified in the one or more conditions 202 and the designated time(s) specified in the delivery time 204 may be used by the server 202 to deliver matching email messages transmitted to the intended recipient at the particular prioritized time or times designated in the delivery schedule 200. More particularly, when a matching email message is received, the server 202 may be configured to withhold the delivery of the matching email message to an inbox or folder of an email client application associated with the recipient's email address until the time window specified by the delivery time 204. The server 102 may withhold the delivery of the matching email message until a designated time even if earlier delivery of the matching email message to the client application of the intended recipient is otherwise possible, and while other (e.g., higher priority) email messages received later in time continued to be delivered to the client application during the period of time the matching email message is withheld from delivery. On the other hand, other email messages (e.g., email messages that oppose (e.g., do not satisfy or meet) the conditions 202 and are not subject to the delivery schedule 200) may be delivered to the inbox or another folder of the email client application associated with the intended recipient as soon as possible instead of being deliberately withheld from delivery until any particular future time as in the case of the matching email messages that are subject to the delivery schedules 200.

As a result, the intended recipient may continue to receive some email messages as soon as possible from the server 102 (e.g., that are deemed to have the highest relative priority in terms of delivery time), while the server 102 may withhold and then deliver other matching email messages at respective later prioritized delivery times based on their relative priority in terms of the designated time of delivery. Such functionality may advantageously enable the recipient to more efficiently process and manage a large number of email messages by having prioritized delivery schedule times for one or more messages relative to other email messages even though some or all of the messages may be deliverable at a much earlier time to the intended recipient.

The one or more exceptions 206 of the delivery schedule 200 may specify exceptional conditions that may be compared or matched by the server 102 with additional information in one or more matching email messages. The exceptional conditions may be used by the server 202 to deliver certain matching email messages to the intended recipient's inbox or other folder notwithstanding the designated future time or times indicated in the delivery time 204. For example, the one or more exceptions 206 may specify that matching email messages that include keywords such as “urgent”, “important”, “asap”, or that are otherwise marked by the sender's email client application as a high priority message, should be delivered to the intended recipient as soon as possible and without being withheld until a future time specified in the delivery time 204. This aspect may be advantageous in configuring the server 102 to generally deliver most matching email messages to the intended recipient at or during preferred times, while also enabling the server 102 to deliver certain smaller number of matching email messages that meet the exceptional conditions 206 as early as possible to the intended recipient without additional delay.

The information included in the delivery schedule 200 described above may be determined in several ways. In one embodiment, the information included in the delivery schedule 200 may be received via the intended recipient's email application. For example, the intended recipient may submit the conditions 202, the delivery time 204, or the exceptions 206 for one or more delivery schedules 200 to the server 102 using one or more interfaces provided by the email application, such as, for example, a dialogue box, a graphical window, or any other graphical or textual interface supported by the email application. In another embodiment, the information for the one or more delivery schedules 200 may be entered and submitted using a web-browser by the intended recipient to the server 102 in one or more web-pages hosted by the server 102. This latter embodiment may advantageous in that the web-pages may be implemented and provided by the server 102 to the intended recipient in a web-browser independent of, and without requiring any modification of, the recipient's preferred email client application.

In yet another embodiment, the information included in the delivery schedule 200 may be dynamically and automatically determined by the server 102 without input by the intended recipient. For example, in one aspect the server 102 is configured to monitor and analyze the recipient's activity with respect one or more email messages delivered by the sever 102 to the recipient's email application. The server is further configured to determine from such monitoring and analysis that the recipient views or responds to particular email messages at particular time or times of the day, irrespective of when the email messages were delivered to the intended recipient. The server 102 may analyze various attributes of such email messages (e.g., the sender, the subject, the content, etc.), and then create one or more delivery schedules 200 for such email messages based on the particular times when the intended recipient clicks on or otherwise processes such email messages. The server 102 may be further configured to provide an option to the intended recipient to approve, reject, or edit such dynamically created delivery rules 200. For example, the server 102 may transmit an email message to the recipient's email address that includes a link to one or more web-pages including the proposed delivery schedules 200. The recipient may open the email message and click on the web-page link which may enable the intended recipient to view the proposed delivery rules and to accept, reject, or edit the proposed delivery rules in a web-browser.

While specific embodiments have been described above with respect to prioritizing delivery of email messages based on a recipient's preferred delivery times, the present disclosure is not limited to any particular type of electronic correspondence. Moreover, it will be appreciated by one or ordinary skill that the systems and methods disclosed herein may also be readily applied to other types of textual or non-textual electronic correspondence that may be received, processed, and transmitted from one computing device to another computing device over a network, such as, for example, text messages, social media messages, RSS feeds, faxes, voice-mails, and the like.

FIG. 3 illustrates an example process-flow diagram 300 which may be implemented in one embodiment of the electronic correspondence system 100. The process begins in step 302. At step 304, the server 102 receives electronic correspondence transmitted by a sender for delivery to an intended recipient over the network 108. For example, an end user of client device 104 (e.g., sender) may use a client application 110 to create and transmit the electronic correspondence to server 102 for delivery to an end user (e.g., an intended recipient) associated with another client application 112 on client device 106. Client applications 110, 112, may be any applications or programs suitable for creating, transmitting, and receiving particular types of electronic correspondence, such as, for example, email messages, text messages, social media messages, RSS feeds, faxes, voice-mails, and the like. The electronic correspondence transmitted from the client device 104 may be received at server 102 over the network 108 in accordance with one or more networking protocols.

At step 306, the server 102 is configured to determine (e.g., by executing server application 114), whether the electronic correspondence received by the server 102 is a matching electronic correspondence or not. For example, the server 102 may compare information in the received electronic correspondence with criteria specified in one or more conditions 202 of a delivery schedule 200. Such comparison of the information in the electronic correspondence may include comparing textual content included within various fields of the electronic correspondence, such as textual content included within the headers, subject, or body portions of the electronic correspondence with the criteria specified in the conditions 202. Such comparing of the information in the electronic correspondence with the criteria specified in the conditions 202 may also include converting any non-textual or binary portions of the electronic correspondence into a suitable textual format (e.g., voice-to-text) as appropriate. The server 102 may determine that the received electronic correspondence is a matching electronic correspondence if the comparison indicates that the information in the electronic correspondence matches the criteria specified in one or more conditions 202. Alternatively, if the information in the electronic correspondence opposes (e.g., does not match) the one or more conditions 202, the server may determine that the electronic correspondence is not a matching electronic correspondence.

At step 308, the server 102 determines, based on the result in step 306, whether or not to withhold the delivery of the electronic correspondence to the intended recipient until a designated (e.g., prioritized) time in the future, even if earlier delivery of the electronic correspondence to the intended recipient is possible. For example, if a determination is made at step 306 that the received electronic correspondence is a matching electronic correspondence, the server 102 may determine to withhold the delivery of the electronic correspondence to the intended recipient until a designated delivery time 204 included in the delivery schedule 200. As noted previously, the server 102 may determine to withhold the delivery of the electronic correspondence even if earlier delivery of the electronic correspondence is possible, for example, to the client application 112 of the client device 106. On the other hand, if a determination is made at step 306 that the electronic correspondence is not a matching electronic correspondence, or, if the server 102 determines that the information in the electronic correspondence matches one or more additional exception conditions 206 specified in the delivery schedule 200, the server 102 may determine to deliver the electronic correspondence to the intended recipient without withholding the electronic correspondence until a future time.

If the server 102 determines in step 308 that the electronic email correspondence is to be delivered without withholding the electronic correspondence until a future time, the process proceeds from step 308 to step 310 in which the server 102 delivers the electronic correspondence to the intended recipient. For example, the server 102 may store the received electronic correspondence in a current delivery queue or delivery buffer accessible to the client application 112 associated intended recipient, and may immediately forward or transmit the electronic correspondence from the delivery queue or buffer to the client application 112 in a push or pull operation as soon as the client application 112 is online and connected with the server application 114 via the network. Upon delivery of the non-matching electronic correspondence to the client application 112 associated with the intended recipient, the process may end at step 312.

On the other hand, if the server 102 determines in step 308 that the electronic correspondence is matching electronic correspondence that is to be withheld from delivery to the intended recipient until a designated time in the future, the process proceeds from step 308 to step 314 in which the server 102 withholds the delivery of the electronic correspondence from the intended recipient. For example, the server 102 may store the matching electronic correspondence in a withholding queue or withholding buffer that is different from the delivery queue or buffer and is inaccessible or transparent to the client application 112. The electronic correspondence may be stored until in the withholding queue or buffer until the designated time of delivery even if it is otherwise possible to deliver the matching electronic correspondence to the client application 112 earlier in a push or pull operation.

Upon withholding the delivery of the matching electronic correspondence from delivery to the intended recipient, the process proceeds from step 314 to step 316, in which the server 102 waits until the designated time of delivery of the withheld electronic correspondence. For example, the server 102 may continue to withhold the delivery of the matching electronic correspondence until the designated time of delivery, at which time the server 102 may move the withheld matching electronic correspondence from the withholding queue to the delivery queue or buffer and proceed to step 310 for delivery of the matching electronic correspondence from the delivery queue or buffer to the intended recipient as described in step 310. Upon delivery of the matching electronic correspondence to the intended recipient, the process may conclude in step 312.

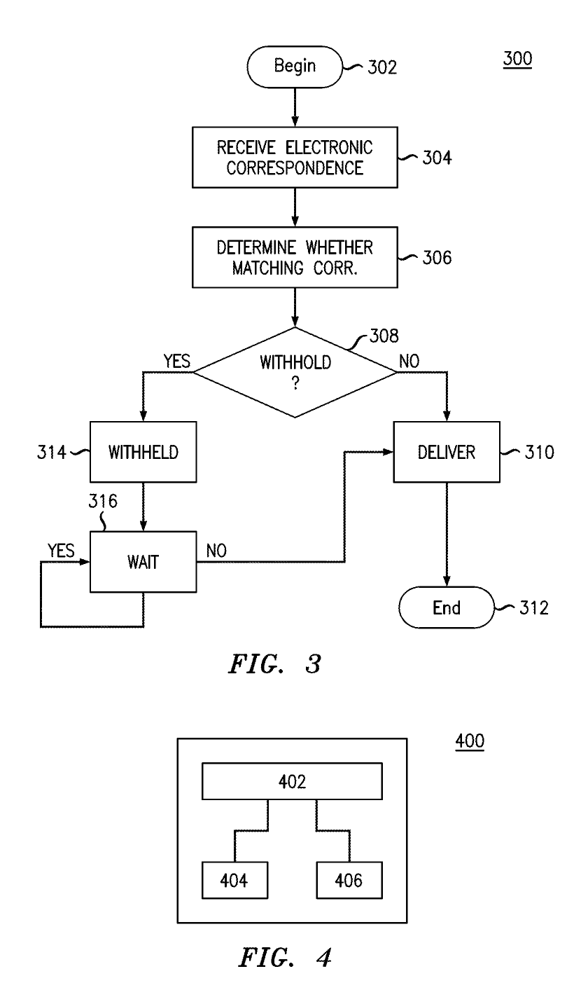

FIG. 4 depicts a high-level block diagram of a computing apparatus 400 suitable for use in performing the various aspects of the systems and methods described herein. As depicted in FIG. 4, apparatus 400 may comprise a processor 402 (e.g., a central processing unit (“CPU”)), that is communicatively interconnected with various input/output devices 404 and a memory 406.

The processor 402 may be any type of processor such as a general purpose central processing unit (“CPU”) or a dedicated microprocessor such as an embedded microcontroller or a digital signal processor (“DSP”). The input/output devices 404 may be any peripheral device operating under the control of the processor 402 and configured to input data into or output data from the apparatus 400, such as, for example, network adapters, data ports, and various user interface devices such as a keyboard, a keypad, a mouse, or a display.

Memory 406 may be any type of memory suitable for storing electronic information, such as, for example, random access memory (RAM), read only memory (ROM), hard disk drive memory, compact disk drive memory, optical memory, etc. The memory 406 may include data and instructions which, upon execution by the processor 402, may configure processor 402 to provide for creating, transmitting, receiving, or processing electronic correspondence over the network as described above. In addition, apparatus 400 may also include an operating system, queue managers, device drivers, or one or more network protocols that are stored in memory 406 and executed by the processor 402.

It will be appreciated that the systems and methods disclosed herein may be generally implemented in software, hardware, or in a combination of software and hardware. For example, in one embodiment the various aspects of the systems and methods disclosed herein such as the creating, transmitting, receiving, or processing of the electronic correspondence over the network may be implemented using one or more application specific integrated circuits (ASICs), field programmable gate arrays (FPGAs), or any other combination of hardware or software.

In addition, it will also be appreciated that while particular functionality has been described with respect to particular devices (e.g., client devices or server devices), the disclosure is not limited to any particular function being implemented in a particular device. For example, it is contemplated that various functions described with respect to the server 102 may be implemented in one or more client devices 104, 106, and vice versa.

Although aspects herein have been described with reference to particular embodiments, it is to be understood that these embodiments are merely illustrative of the principles and applications of the present disclosure. It is therefore to be understood that numerous modifications can be made to the illustrative embodiments and that other arrangements can be devised without departing from the spirit and scope of the disclosure.

1. A method of processing comprising:
receiving a first electronic correspondence for delivery to a client application;
using a processor, determining that information in the first electronic correspondence matches one or more criteria in a first delivery schedule; and,
determining a first scheduled time based on the first delivery schedule for delivering the first electronic correspondence to the client application, the first scheduled time being determined based on the one or more criteria in the first delivery schedule.

2. The method of claim 1, further comprising:
withholding delivery of the first electronic correspondence to the client application at least until the first scheduled time determined based on the one or more criteria in the first delivery schedule.

3. The method of claim 1, further comprising:
receiving a second electronic correspondence for delivery to the client application, the second electronic correspondence being received prior to receiving the first electronic correspondence;
using the processor, determining that information in the second electronic correspondence matches one or more criteria in a second delivery schedule; and,
determining a second scheduled time for delivering the second electronic correspondence to the client application, the second scheduled time being determined based on the one or more criteria in the second delivery schedule and, the second scheduled time for delivering the second electronic correspondence being later than the first scheduled time for delivering the first electronic correspondence.

4. The method of claim 3, further comprising:
determining the second electronic correspondence has a lower priority than the first electronic correspondence based on a determination that the second scheduled time for delivering the second electronic correspondence is later than the first scheduled time for delivering the first electronic correspondence.

5. The method of claim 4, further comprising:
withholding delivery of the second electronic correspondence to the client application at least until the second scheduled time determined based on the one or more criteria in the second delivery schedule.

6. The method of claim 3, further comprising:
receiving a third electronic correspondence for delivery to the client application, the third electronic correspondence being received at a time subsequent to receiving the first and the second electronic correspondence;
using the processor, determining that information in the third electronic correspondence opposes the one or more criteria in the first and the second delivery schedule; and,
determining that the third electronic correspondence has a higher priority than the first electronic and the second electronic correspondence.

7. The method of claim 6, further comprising:
delivering the third electronic correspondence to the client device at a time prior to delivering the first electronic correspondence and the second electronic correspondence to the client application.

8. The method of claim 1, further comprising:
identifying a recipient for the first electronic correspondence; and,
selecting the first delivery schedule from a plurality of schedules based on the identity of the recipient for the first electronic correspondence.

9. The method of claim 1, further comprising:
identifying one or more keywords in the information in the first electronic correspondence; and,
selecting the first delivery schedule from a plurality of schedules based on the one or more keywords identified in the information in the first electronic correspondence.

10. The method of claim 2, wherein withholding delivery of the first electronic correspondence to the client application further comprises:
storing the first electronic correspondence in a first buffer separate from a second buffer; and,
automatically moving the first electronic correspondence from the first buffer to the second buffer at least after the first scheduled time.

11. The method of claim 10, wherein:
delivering the first electronic correspondence from the second buffer to the client application.

12. The method of claim 1, further comprising:
determining the first scheduled time for delivering the first electronic correspondence and at least one of the one or more criteria in the first delivery schedule based on input received from the client application.

13. An apparatus comprising:
a processor;
a memory communicatively connected to the processor, the memory storing one or more executable instructions, which, upon execution by the processor, configure the processor for:
receiving a first electronic correspondence for delivery to a client application;
determining that information in the first electronic correspondence matches one or more criteria in a first delivery schedule; and,
determining a first scheduled time based on the first delivery schedule for delivering the first electronic correspondence to the client application, the first scheduled time being determined based on the one or more criteria in the first delivery schedule.

14. The apparatus of claim 13, wherein the processor is further configured for:
withholding delivery of the first electronic correspondence to the client application at least until the first scheduled time determined based on the one or more criteria in the first delivery schedule.

15. The apparatus of claim 13, wherein the processor is further configured for:
receiving a second electronic correspondence for delivery to the client application, the second electronic correspondence being received prior to receiving the first electronic correspondence;
determining that information in the second electronic correspondence matches one or more criteria in a second delivery schedule; and,
determining a second scheduled time for delivering the second electronic correspondence to the client application, the second scheduled time being determined based on the one or more criteria in the second delivery schedule and, the second scheduled time for delivering the second electronic correspondence being later than the first scheduled time for delivering the first electronic correspondence.

16. The apparatus of claim 15, wherein the processor is further configured for:
determining the second electronic correspondence has a lower priority than the first electronic correspondence based on a determination that the second scheduled time for delivering the second electronic correspondence is later than the first scheduled time for delivering the first electronic correspondence.

17. The apparatus of claim 16, wherein the processor is further configured for:
withholding delivery of the second electronic correspondence to the client application at least until the second scheduled time determined based on the one or more criteria in the second delivery schedule.

18. The apparatus of claim 15, wherein the processor is further configured for:
receiving a third electronic correspondence for delivery to the client application, the third electronic correspondence being received at a time subsequent to receiving the first and the second electronic correspondence;
determining that information in the third electronic correspondence opposes the one or more criteria in the first and the second delivery schedule; and,
determining that the third electronic correspondence has a higher priority than the first electronic and the second electronic correspondence.

19. The apparatus of claim 18, wherein the processor is further configured for:
delivering the third electronic correspondence to the client device at a time prior to delivering the first electronic correspondence and the second electronic correspondence to the client application.

20. The apparatus of claim 13, wherein the processor is further configured for:
identifying a recipient for the first electronic correspondence; and,
selecting the first delivery schedule from a plurality of schedules based on the identity of the recipient for the first electronic correspondence.
